(19) United States
(12) Patent Application Publication
(10) Pub. No.: US 2016/0277577 A1
(43) Pub. Date: Sep. 22, 2016

(54) Audio File Metadata Event Labeling and Data Analysis

(71) Applicant: TopBox, LLC, Potomac, MD (US)

(72) Inventors: Jeffrey Stephen Yentis, Potomac, MD (US); Christopher Lee Tranquill, Sherwood, OR (US); Brian Keith Timmons, Highlands Ranch, CO (US); Ryan Andrew Studer, Lees Summit, MO (US); Micheal Dean Dobson, Lees Summit, MO (US)

(21) Appl. No.: 15/076,572

(22) Filed: Mar. 21, 2016

Related U.S. Application Data
(60) Provisional application No. 62/136,114, filed on Mar. 20, 2015.

(51) Int. Cl. H04M 3/51; G10L 21/12; G06F 3/16; G06F 17/24; G06F 3/0482; G06F 3/0484; G06F 3/0481; H04M 3/42; G06F 17/30

(52) U.S. Cl. CPC H04M 3/5175; H04M 3/42221; G10L 21/12; G06F 3/165; G06F 17/30648; G06F 3/0482; G06F 3/04842; G06F 3/04817; G06F 17/24

(57) ABSTRACT

An interaction management system receives audio files of interactions between customers and customer service agents and client provided metadata from a client. The interaction management system provides an interface for creating enhanced metadata based on the received audio file and client provided metadata using a capture interface. The capture interface allows a user to label the audio file with event labels and sentiment labels at particular time stamps in the audio file. The interaction management system saves the captured metadata in an interaction file associated with the client provided audio file to be presented back to the user as a visual sequential representation of the captured data.

### CROSS REFERENCE TO RELATED APPLICATIONS

This application claims the benefit of U.S. Provisional Application No. 62/136,114, filed Mar. 20, 2015, which is incorporated by reference in its entirety.

### BACKGROUND

Customer contact centers are a corporation's way to determine the wants and needs of their customers with regard to their product or services. Problems with products, services, billing, etc. create often enter a company's awareness through a customer contact center. End users—the customers—contact the company because they are experiencing symptoms stemming from those problems. Those symptoms are related to a root cause, typically occurring somewhere upstream of the contact center. An inability to identify root cause quickly and accurately can cause companies to lose millions of dollars in customer churn, missed revenue opportunities and increased cost to serve. However, root cause identification has been difficult historically for a variety of reasons including, multiple and disparate customer relationship management systems, disparate databases with uncommon data taxonomies, incomplete contact data that provides limited or no intra-contact data, inability to create or aggregate intra-call data, random contact monitoring that does not target specific symptoms, and no visualization of customer contact (must listen to an entire call to understand an issue). This inability to contextualize the series of events occurring within customer interactions limits the ability to identify root cause and act to resolve it.

### BRIEF DESCRIPTION OF DRAWINGS

FIG. 1 is a flow diagram illustrating the process of capturing and analyzing interaction metadata in accordance with one embodiment.

FIGS. 2A-2I are illustrations of the capture interface for capturing interaction metadata in accordance with on embodiment.

FIG. 3 is an illustration of the review interface in accordance with one embodiment.

FIGS. 4A-4G are illustrations of the targeting interface in accordance with one embodiment.

FIGS. 5A-5B illustrate the process of creating quality assurance forms using the review interface in accordance with one embodiment.

### DETAILED DESCRIPTION

### Root Cause Identification Process

An interaction management system captures and processes metadata and contextualizes customer interactions to identify the root cause of a customer service problem. The interaction management system receives or records audio files of interactions between customers and customer service representatives, targets recorded interactions for observation, presents the targeted interactions for observation, enables capture of metadata describing the details of each targeted interaction, displays the interaction metadata in relation to the audio file, analyzes the observed interactions, generates quality assurance forms based on the interaction metadata, and updates interaction metadata based on root causes determined in the interaction analysis process. In addition, the interaction management system incorporates a number of data analysis tools and metadata management software that enable the functions described above. An interaction may be any interaction between a customer and a representative of a business or corporation including but not limited to calls from a customer to a customer support center, marketing calls from a call center to a potential customer, online chat room interactions between a customer and customer support staff, or the like.

The interaction management system may be used in a call center or a customer relations management environment, or any other environment wherein audio recordings are generated in the process of providing customers with support with products or services offered by the related corporation or business. In addition, the interaction management system may be applied to text interactions between a customer and customer support entities and may be applied to other non-audible customer relations environments. These customer relations environments include many agents handling interactions with customers. These interactions are recorded and may be analyzed by management and quality assurance staff. An agent's computer may be connected to an internal network and the internet to provide additional services to the customer during the call. Quality assurance or management personnel may use the interaction management system from any computer with access to the interaction management system to perform the functions described herein. The interaction management system may receive interactions from remotely-located agents to evaluate the performance of the agents without interfacing directly with each agent or the agent's computer.

Herein, the term “observer” may refer to a number of different possible people in a customer relations management environment. The observer might be the call agent, call center quality assurance personnel, upper management or management, an external customer service consultant, or any other suitable person wanting to perform the functions provided by the interaction management system. The terms “caller” and “customer” refer to the person engaging in an interaction with a customer service agent. “Observations” or “observed interactions” refer to interactions for which enhanced metadata has already been captured, while the term “unobserved interactions” refers to recorded interactions that have not yet been tagged with enhanced metadata but are stored by the system. Thus, “observation” refers to whether enhanced metadata has been added for an interaction.

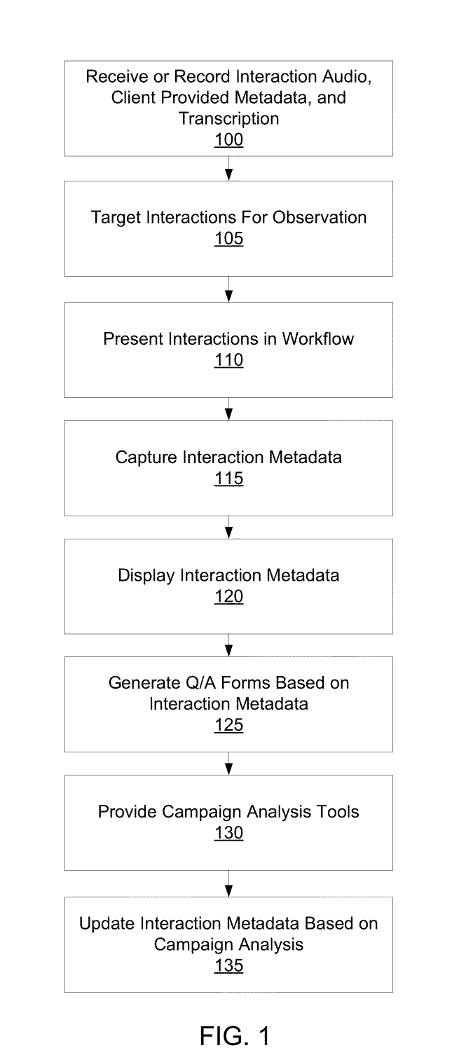

FIG. 1 is a flow diagram illustrating the interaction metadata analysis process in accordance with some embodiments. The call metadata analysis process is comprised of the following steps: receiving recorded audio interactions or recording audio interactions and client provided metadata 100, targeting interactions for observation 105, presenting interactions in an observer workflow 110, capturing enhanced interaction metadata 115, displaying interaction metadata 120, generating quality assurance forms based on interaction metadata, 125, providing campaign analysis tools 130, and updating interaction metadata based on campaign analysis 135. These steps may be performed in any order as requested by an observer. Additionally, depending on previously captured interaction metadata and information, each step may not rely on the completion of the previous step and may be conducted independently.

The interaction management system may be configured to receive recorded audio files of interactions between a customer and an agent 100. An audio file may be stored using a variety of common formats. Alternatively, the audio file may be stored in a custom format designed for the application of audio metadata. The interaction management system may also be configured to accept a plurality of audio file formats. Upon receiving interaction data from a client, the interaction management system may also receive client metadata. The metadata received from a client may include information on the source of the audio file and the length of audio file as well as other contextual information. Examples of client provided metadata are provided below. The interaction management system may receive the client provided metadata in a number of suitable data table formats.

The audio files may be uploaded to a database of the interaction management system from the database of a call center or other original storage location owned by a client business or corporation of the interaction management system. Alternatively, the interaction management system may be configured to retrieve audio files from a predetermined location on a server of a customer service center. In some embodiments the interaction management system may be integrated with the telephone system other system allowing interactions between a customer and an agent. In other embodiments, the interaction management system may perform the recording of audio file that would normally be conducted by the client. By recording the audio files directly, the interaction management system may record higher quality audio files that facilitates processing of the audio data. Additionally, the interaction management system will have greater control by creating the metadata usually created by the client's recording process.

Upon receipt of an audio file of an interaction, the interaction management system creates an “interaction file” for the audio file. The term “interaction file” refers to the combination of the recorded audio file of an interaction and all metadata associated with the interaction. Metadata associated with the interaction are comprised of the following categories of metadata: client provided metadata, transcript metadata, and observation metadata. Each component of the interaction file is associated with the interaction file based on an observation key that is unique to each interaction.

Client provided metadata are metadata provided by a client of the interaction management system upon delivery to the interaction management system. Examples of client provided metadata include the length of the interaction, the agent responsible for the interaction, the category of the interaction (billing, IT, security, etc.), or the location of the agent responsible for the interaction. Client provided metadata may also include transaction metadata, such as a billing history for a customer involved in an interaction.

Transcript metadata may include transcripts of each audio file received by the interaction management system or other media type. An interaction transcript is created for each interaction in the interaction management system based on the received interactions between a customer and the client. An interaction transcript is a text file that is a transcript of the interaction recorded in an audio file. The interaction transcript is created using voice recognition software. The interaction transcript may be automatically generated by the interaction management system upon receipt of an audio file. Alternatively, the interaction management system may generate an interaction transcript after an interaction has been targeted for observation by an observer.

An interaction transcript may be stored in a variety of standard formats. Alternatively, the interaction transcript may be stored in a custom format for the application of interaction metadata. For example, an interaction transcript may be saved such that each word of the transcript is associated with a timestamp in the audio file. The interaction transcript may also be stored such that the speaker of each word is identified as either the customer or the agent (or any other participant in the call).

In some embodiments, an interaction transcript may also include transcripts of interactions outside of the recorded audio using other electronic media.

Observation metadata are metadata created by human observers using the interaction management system during the capturing interaction metadata process 115. Observation metadata may also include machine captured metadata that may be automatically generated based on client provided metadata and transcript metadata.

For human captured observation metadata, a capture interface provided by the interaction management system allows for intuitive creation of metadata for an audio interaction. Allowing observers to create a record of the details and characteristics of the interaction linked directly to particular locations of the audio file corresponding to each recorded detail. In the case of machine captured observation metadata the interaction management system may analyze either the transcript metadata or the audio of the interaction to create metadata based on particular qualifications for each tag. For example, a label could be applied to an interaction automatically if the transcript of the interaction does not include a customer service agent presenting a promotional offer to a customer. Both human captured and machine captured observation metadata may include timeline entries or campaigns labels.

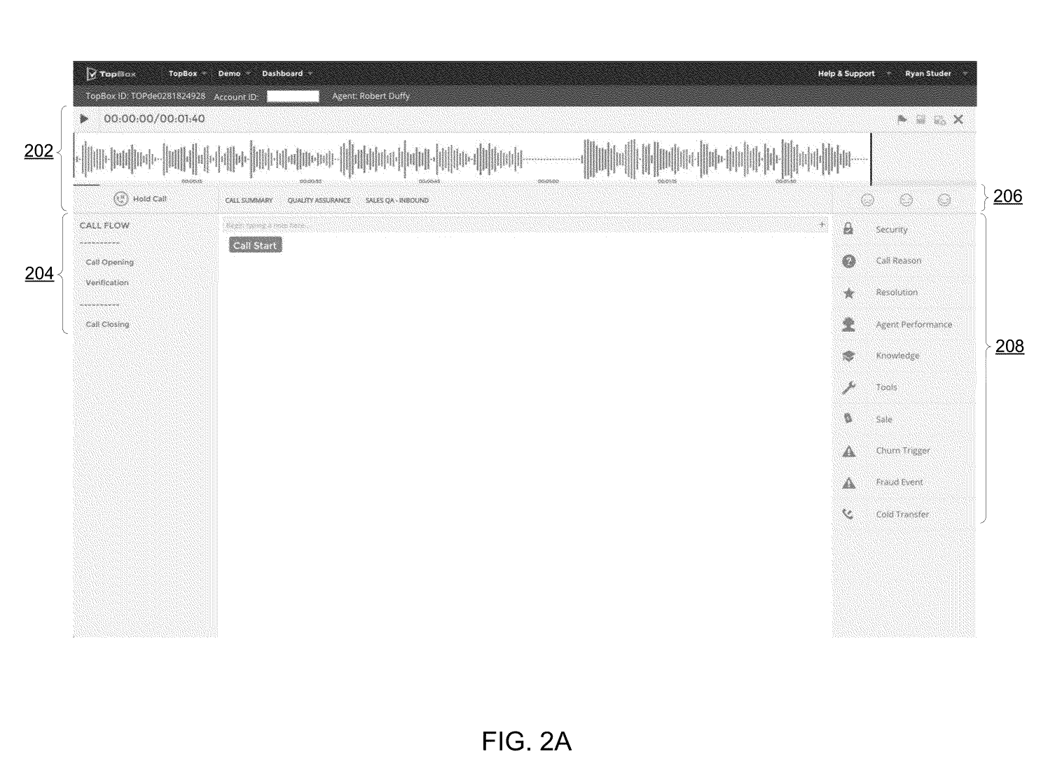

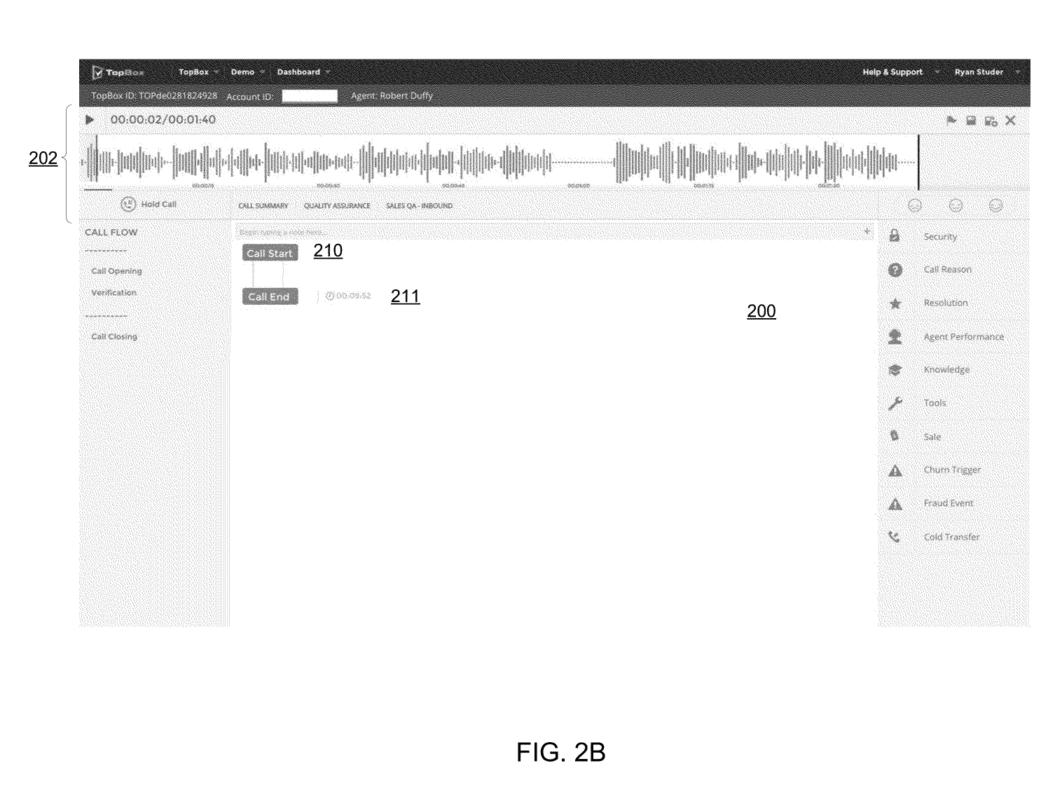

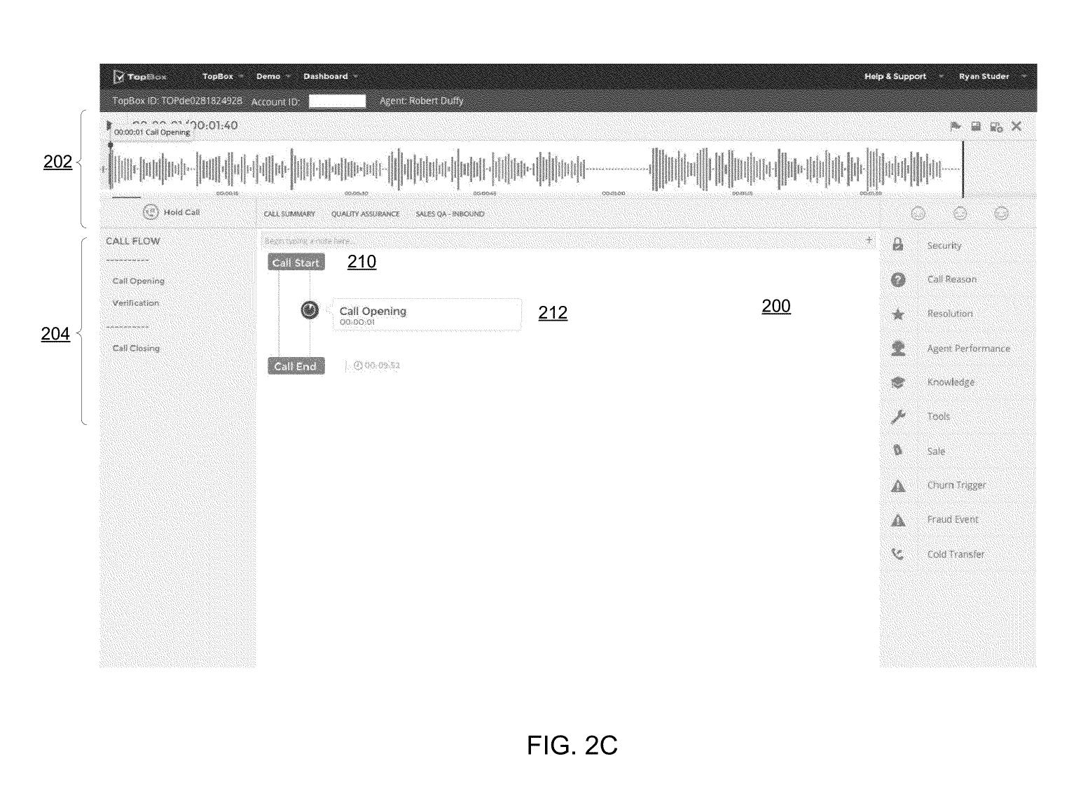

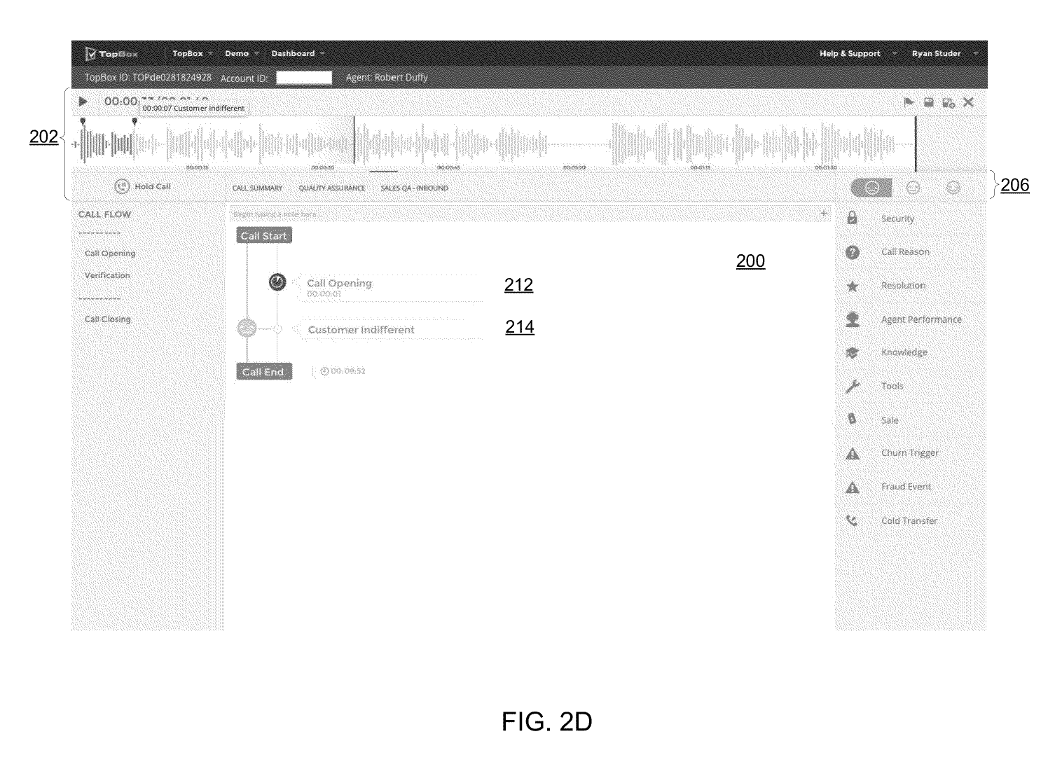

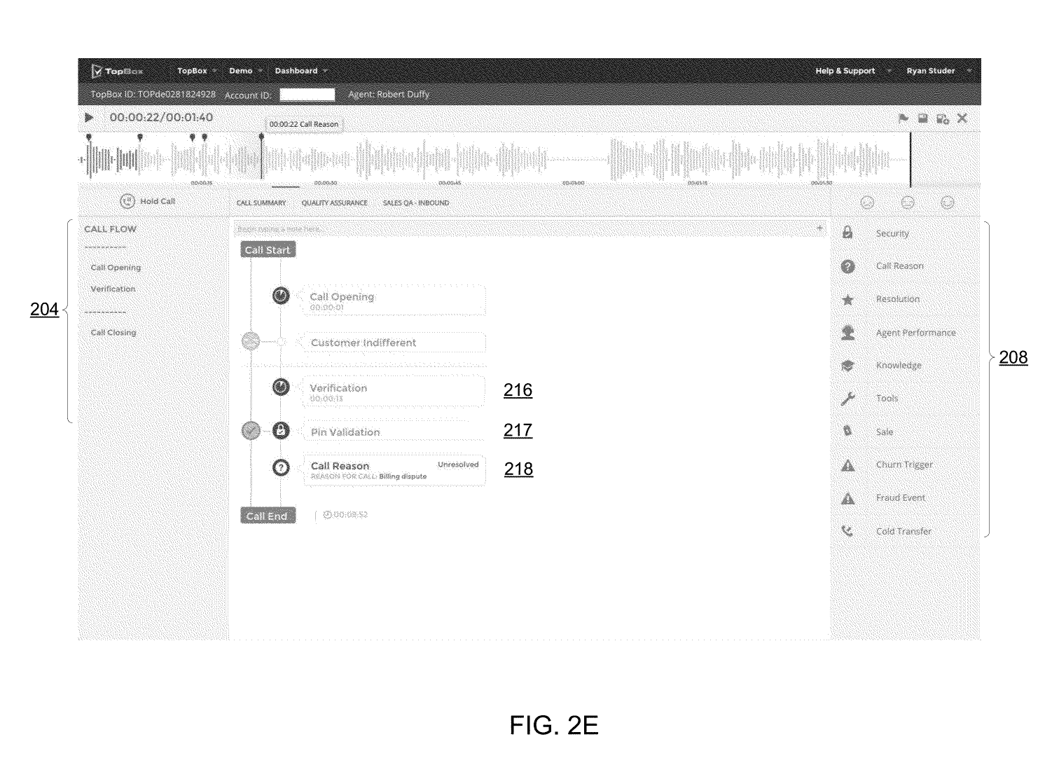

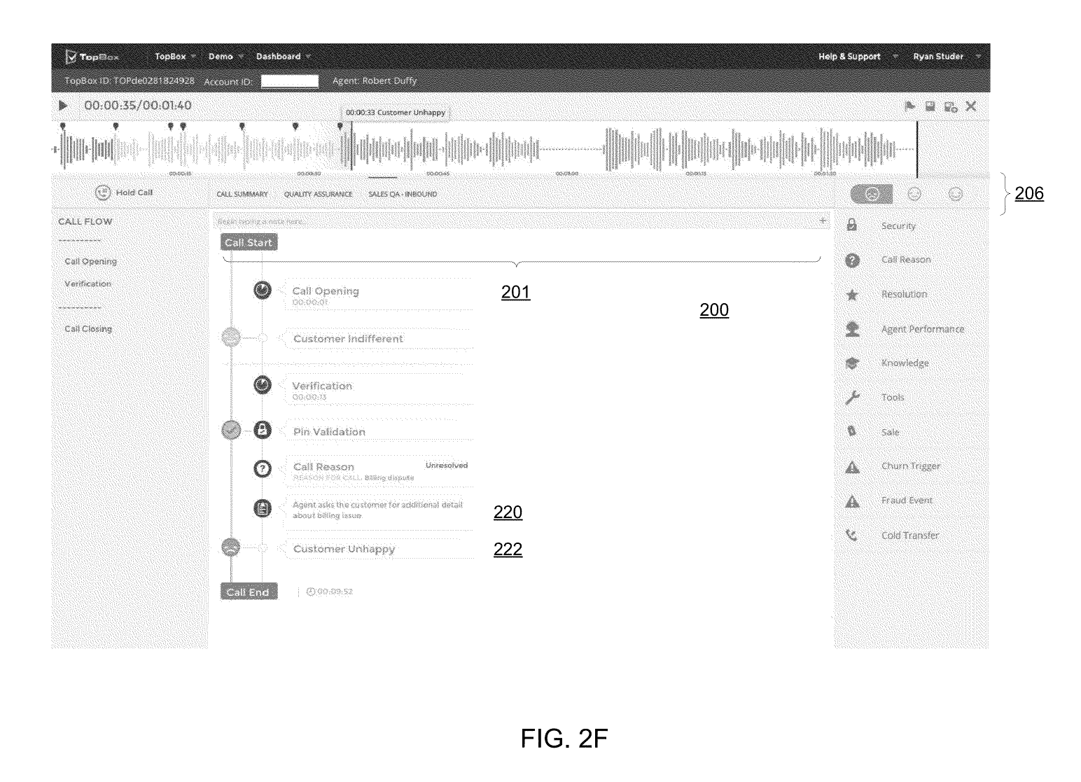

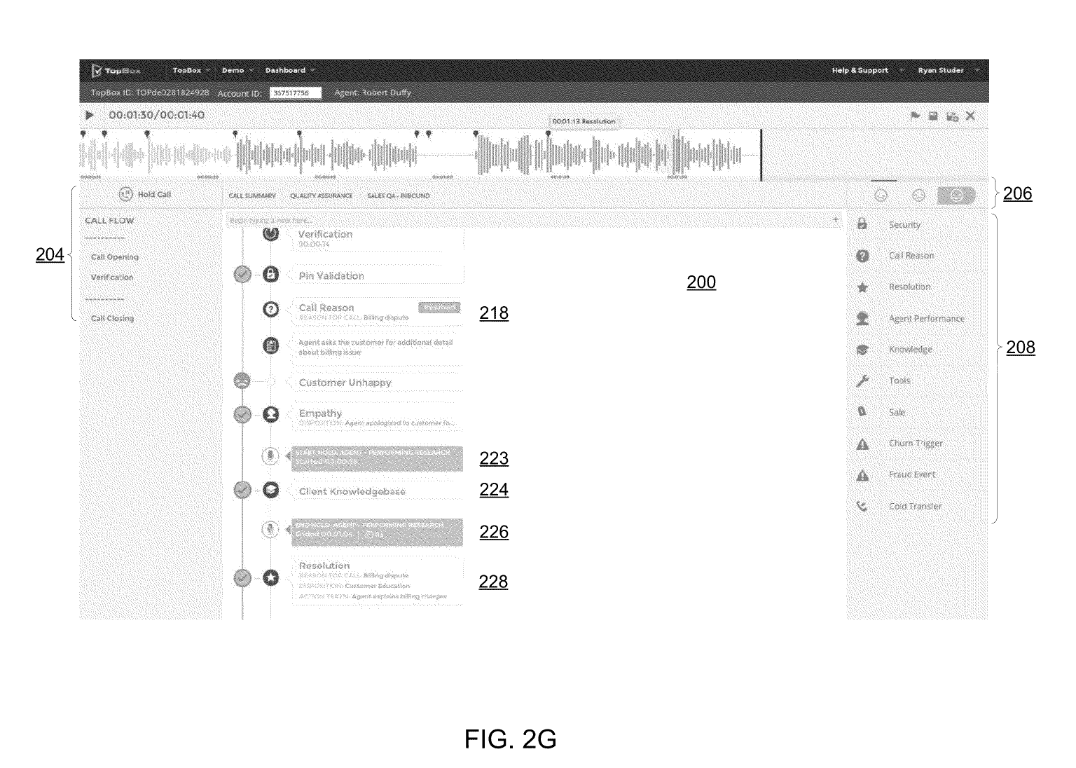

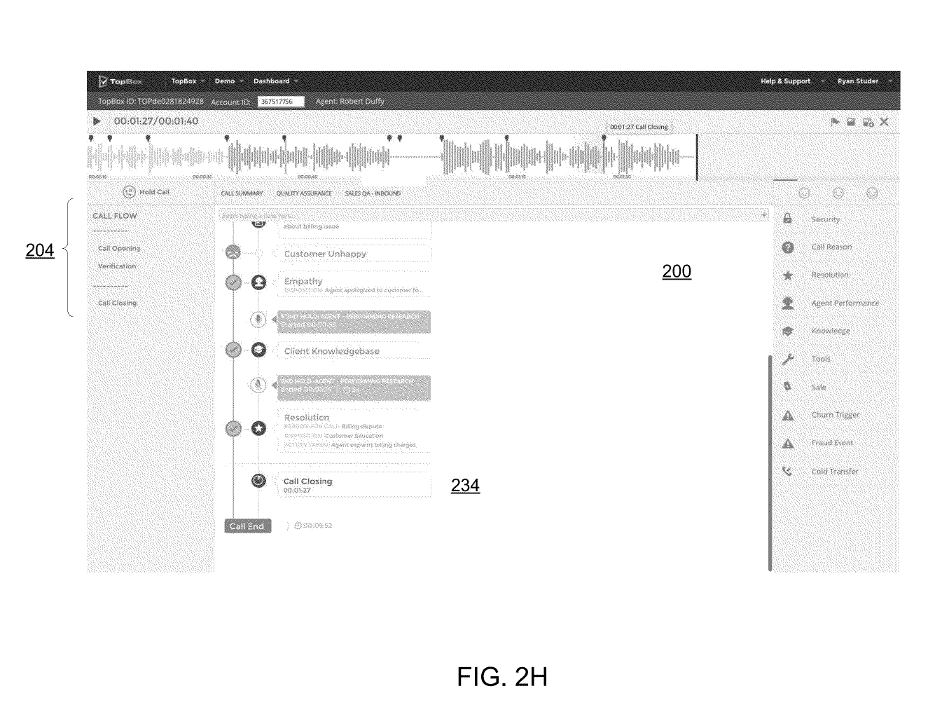

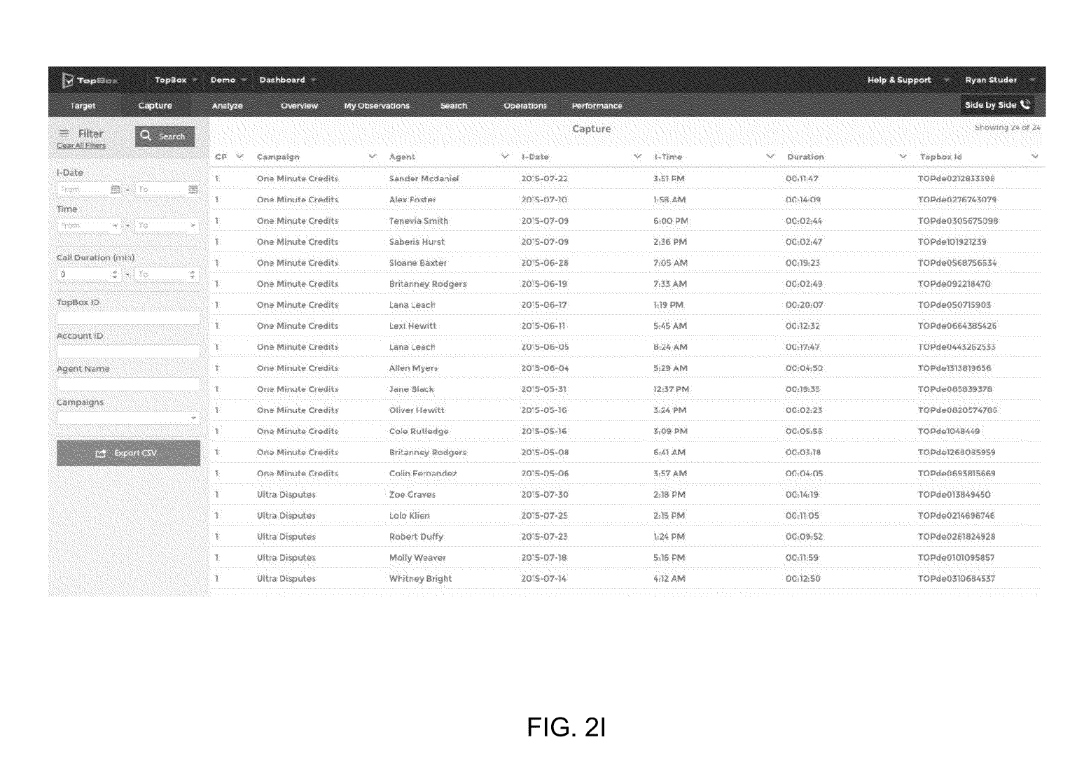

Timeline entries are events that have been associated with the interaction using the capture interface. Timeline entries may represent any event during the interaction. Specific examples are discussed with reference to FIG. 2. Timeline entries may have an event identifier that indicates the event that occurred, a timestamp to indicate the time at which the event occurred within the interaction, and any additional informational fields that may be edited during observation. Alternatively, a timeline entry may represent a “state” of a call that may have a start and an end timestamp. For example, a timeline entry may indicate that the agent has placed a caller on hold, and a timestamp indicates the beginning of the hold period and the end of the hold period. A timeline entry can be machine generated by the interaction management system based on predefined audio or textual criteria.

Active campaigns are metadata tags that indicate whether the interaction file is being used for an analytic campaign. The active campaign tag functions to allow the interaction management system to perform data analysis on the call file during an analytic campaign as well as present the interaction to an observer for further metadata capture.

The term “campaign” refers to an object defined in the interaction management system that defines a set of interactions to be observed for metadata capture and further analysis. Thus a campaign may be associated with unobserved interactions, observed interactions, and analyzed interactions depending on the state of the campaign. A campaign may be initially defined by an administrator using the interaction management system. An administrator may define a campaign in terms of a hypothesis about a problem occurring in a subject customer relations environment. The campaign object itself may contain a text file describing the purpose of the campaign. The campaign is further refined in the targeting interactions for observation process 105. During the targeting process, which is further described below, the administrator defines the interactions of interest for the campaign based on client provided metadata or observation metadata that has already been captured by observers or has been automatically applied by a process of the interaction management system.

Alternatively a campaign may be auto-generated by the interaction management system based on a set of criteria set by an administrator. In this embodiment, the interaction management system may flag interactions for inclusion in a campaign based on client provided metadata, transcription metadata or observed metadata. For example, the interaction management system may be configured to automatically add any interaction with observation metadata indicating a perceived negative customer sentiment lasting longer than thirty seconds in an interaction.

Once targeting criteria for a campaign have been determined in the targeting process 105 an administrator may designate the campaign as open to additional interactions or closed to additional interactions. This indicates whether additional interactions can be added to the campaign. In some embodiments, the interaction management system automatically assigns a newly received interaction to a campaign if a campaign is designated as “Active or System” and the campaign has targeting criteria that match the client provided metadata of the new interaction. If a campaign is designated as active the interaction management system may enable the capture workflow depicted with reference to capturing interaction metadata 115.

Additionally, an administrator may define a campaign goal indicating how many interactions must be observed to provide a satisfactory data set for an analysis of the campaign. In some embodiments, the interaction management system may determine a campaign goal automatically given a desired confidence level.

A campaign may also be assigned a campaign priority, which allows the interaction management system to prioritize interactions for observation during the presenting interactions in a workflow process 110, which is described in more detail below.

Observation form metadata are data from quality assurance forms that may be generated by an administrator and completed based on the timeline entries of an interaction. Both the questions and the answer comprising the observation form may be stored as metadata and associated with the audio file. The questions and answers of the observation forms may be linked to other timeline entries or other metadata. Particular questions and answers may have associated timestamps indicating the point in the interaction at which the answer to a question was determined or what event the question was generated from. The process of generating quality assurance forms is addressed in more detail with reference to the generating quality assurance forms based on interaction metadata process 125.

A keyword tag indicates that a particular keyword occurs in the interaction transcript, timeline entries created by the client in the Client Administration Console referenced in or any other text associated with the interaction file. Keyword tags may be assigned automatically by the interaction management system or by an observer or administrator.

The interaction management system may assign actionable metadata labels to observed interactions that exhibit similar metadata characteristics based on the results of previous analytic campaigns. The interaction management system may also be configured to take some action corresponding to the particular label. The metadata labeling process is described in more detail in the updating interaction metadata based on campaign analysis process 135.

### Campaign Flow Interface

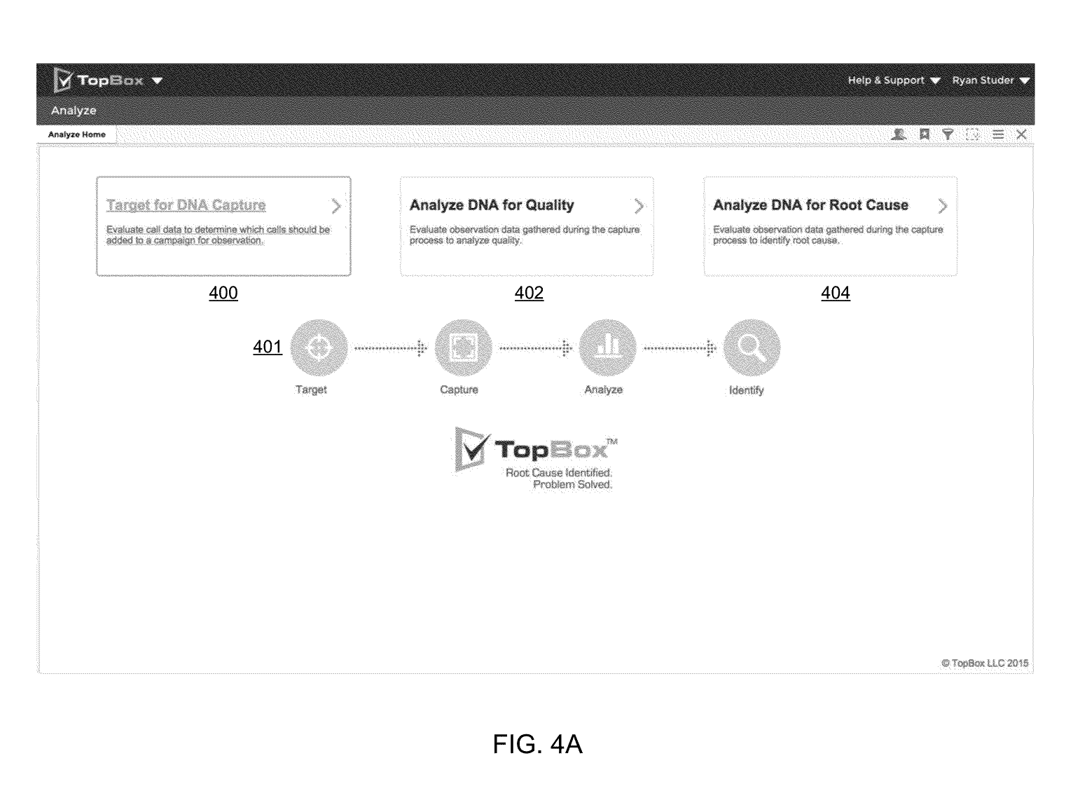

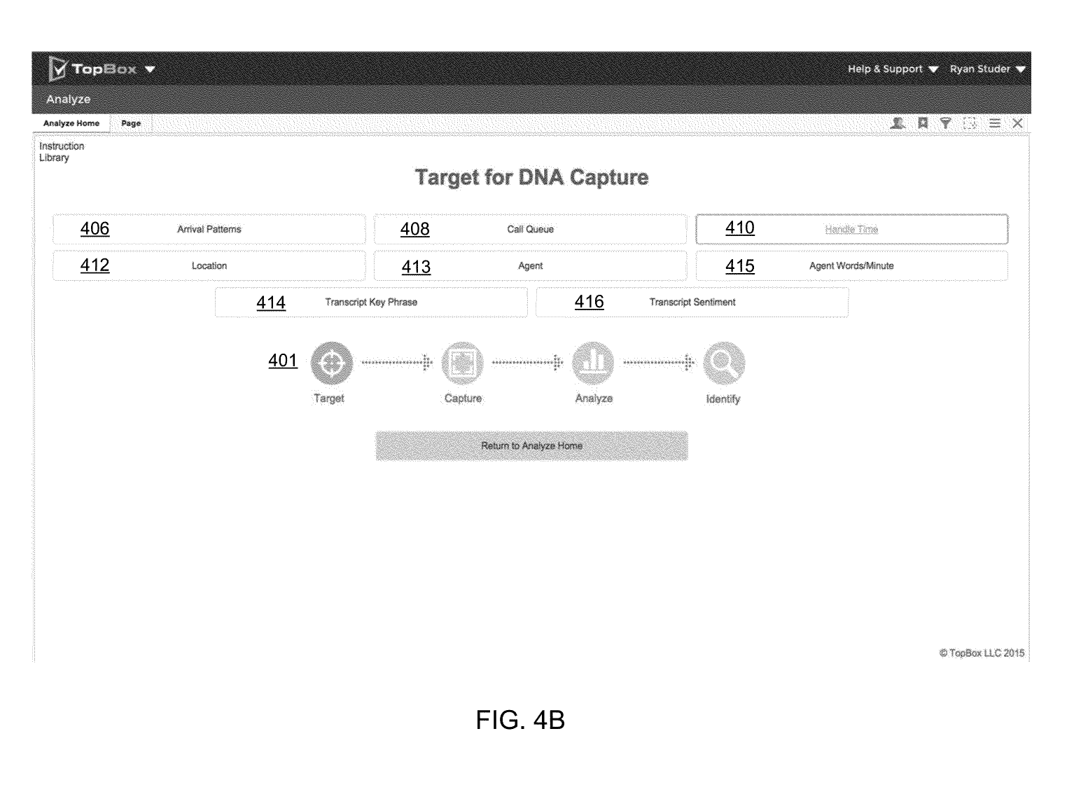

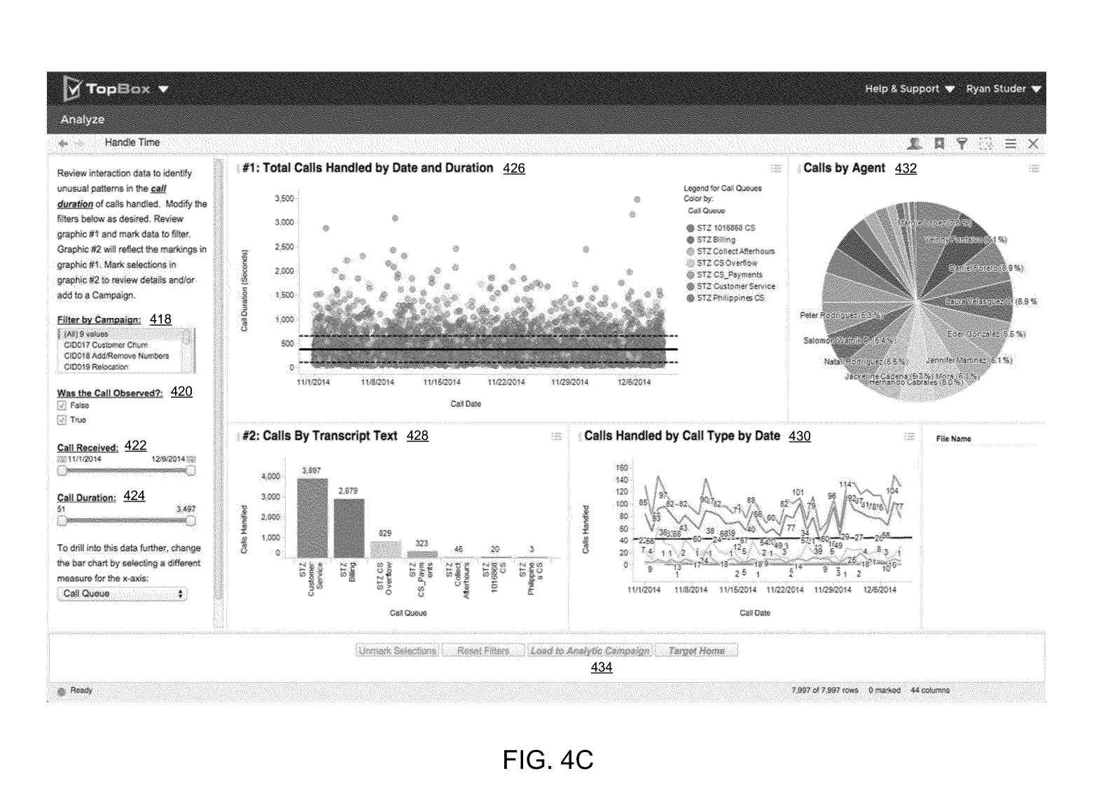

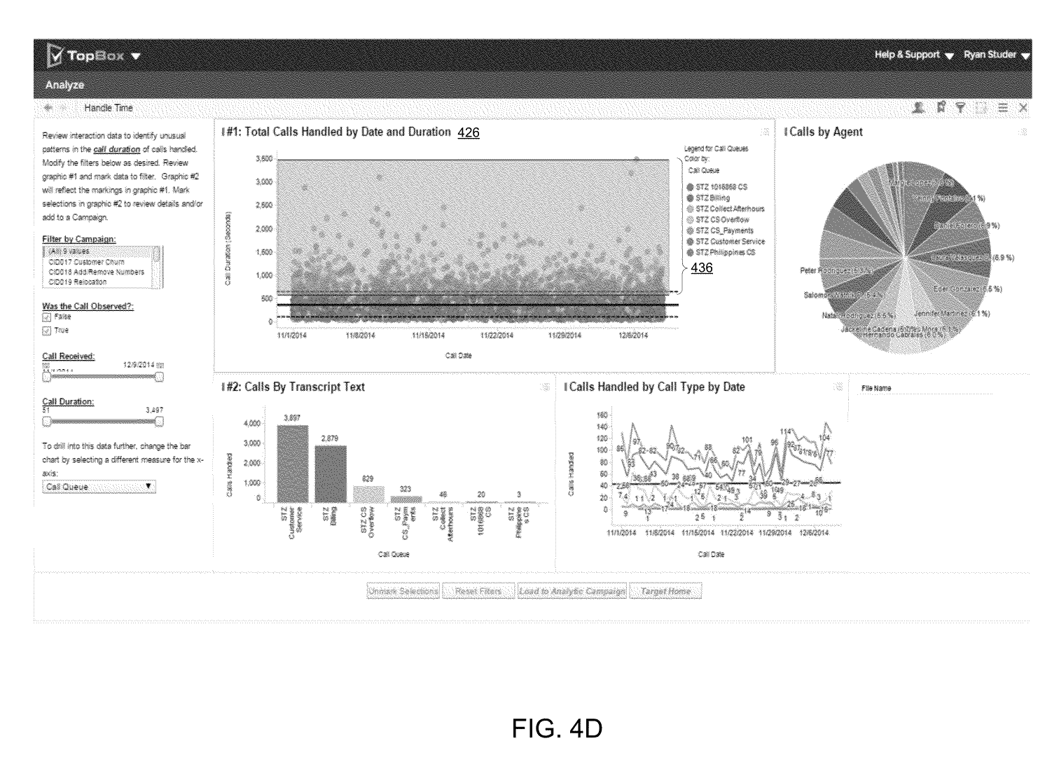

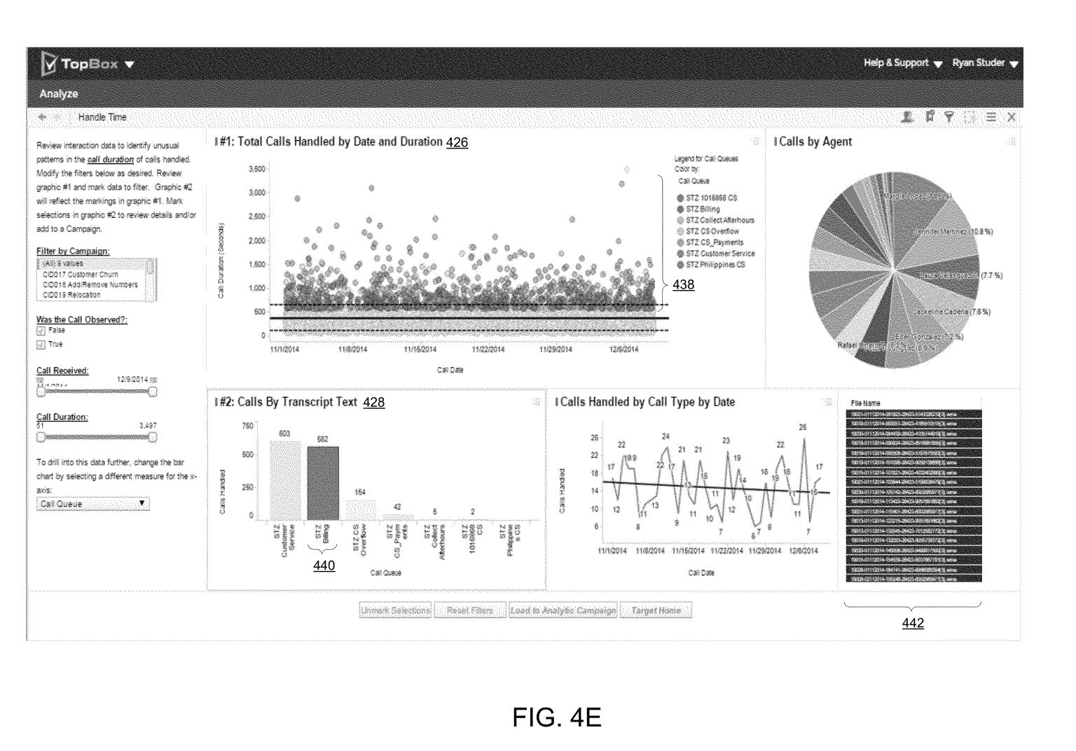

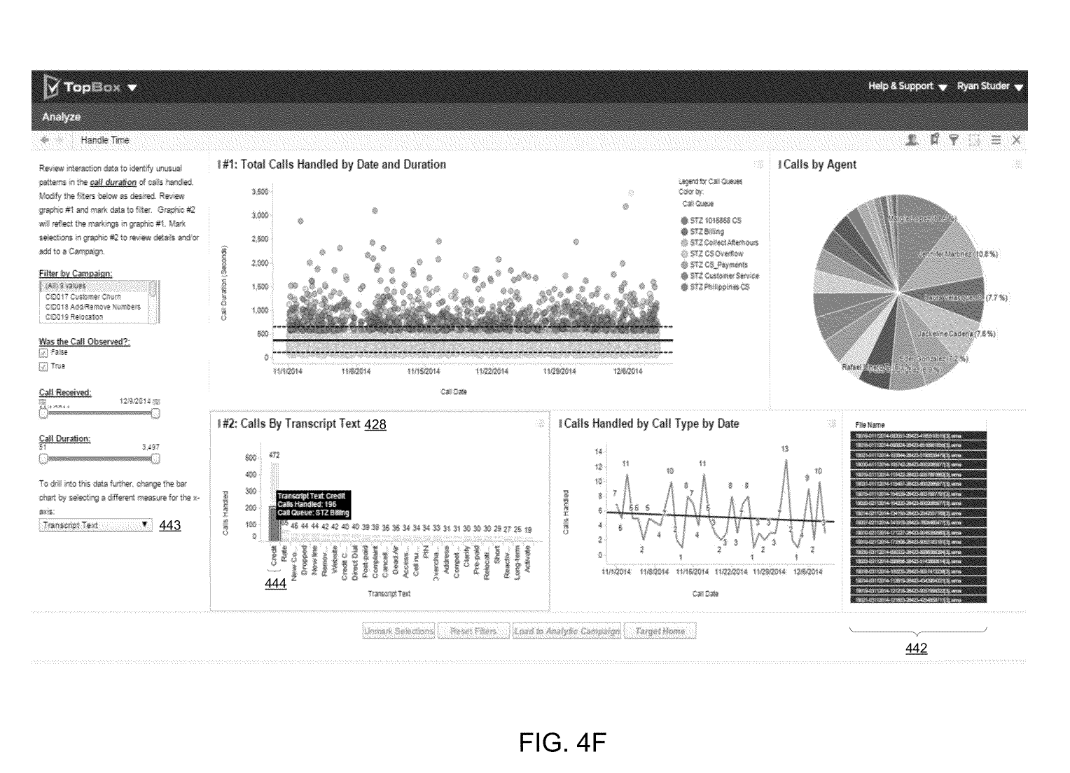

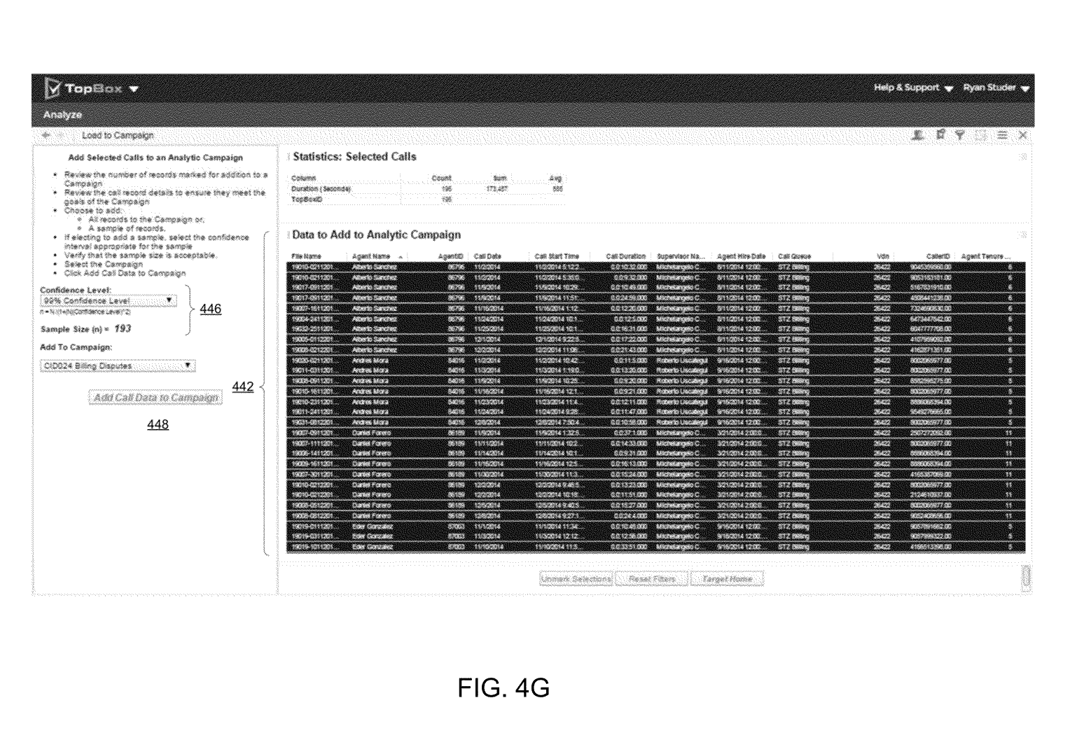

FIG. 4A shows a campaign flow interface including a plurality of option icons that may be implemented by the interaction management system upon the creation of a campaign in accordance with some embodiments. The option icons include but are not limited to targeting interactions for metadata capture 400, analyzing metadata for quality 402, and analyzing metadata to identify root cause 404. In addition to these option icons, process icons may be displayed 401 to progress through the interaction management system.

The targeting interactions for metadata capture icon 400 may initiate the targeting interface to narrow the field from a large number of unobserved interactions to only those unobserved interactions that are interesting to the observer (e.g. interactions with an especially long duration). The targeting interface uses client provided metadata and interaction transcripts with which to target potentially interesting interactions. In some embodiments, interactions targeted using this process may be presented to observers in a workflow interface 110 for quick consecutive capture of interaction metadata, which is described below. The targeted interactions may be added to an analytic campaign that may be further refined by the observer after metadata capture, before being processed by steps 402 or 404.

Analyzing metadata for quality 402 is a process that calculates statistics regarding the effectiveness of call center service and particular agents. For this process, metadata for the interactions targeted in step 400 are analyzed. In some embodiments typical quality assurance metrics may be generated in addition to more advanced statistical breakdowns by agent or call center division, or using observation metadata. This function provides internal data useful for quality assurance purposes.

Analyzing metadata for root cause identification 404 is a process that calculates statistics to identify the root cause of an observed problem. After the interactions that are potentially affected by the problem have been targeted in step 404 and compiled into an analytic campaign, this process provides tools to aid in the identification of a root cause. In some embodiments, similarities across the interactions targeted for the analytic campaign may be analyzed including similarities in keywords in the transcription, keywords from timeline entries, tools, behaviors, or other timeline events that have been used across interactions, patterns involving the sentiment of the user in response to various timeline events, or any other suitable metric for determining similarities between interactions. Process 404 may also provide tools that splice sections of audio across interactions of the analytic campaign corresponding to particular timeline entries to allow for further investigation. Splicing refers to the selective sampling of particular moments in an interaction. For example, if the campaign analysis results in an identification that significant customer dissatisfaction stems from the use of a particular tool, the interactions that comprise that campaign can be spliced such that only the portion of the interaction pertaining to the use of the tool is played back for the observer to hear. Splicing can be accomplished based of the timestamps stored in association with each timeline entry and selectively playing the portion of an interaction associated with a designated timeline entry.

In some embodiments, the process icons 401 may indicate the current state of an analytic campaign. Although the process may be displayed as a linear series of steps, in some embodiments the steps may be performed out of order or in isolation from other steps as long as the correct data inputs for each step have been received by the interaction management system.

### Targeting Interactions for Observation

FIG. 4B illustrates an interface for selecting targeting criteria for targeting process 400, which selects interactions to be observed in an analytic campaign 105, in accordance with some embodiments. The interface includes various selectable icons representing criteria that can be used to target interactions to add to an analytic campaign. Upon the selection of an icon the observer is displayed an additional interface that offers more detailed targeting tools. The icons in the targeting criteria interface each correspond to a specific targeting criteria which include but are not limited to an arrival patterns icon 406, an interaction queue icon 408, a handle time icon 410, a location icon 412, an agent icon 413, a transcript key phrase icon 414, an agent words per minute icon 415, and a transcript sentiment icon 416. In addition to the displayed icons, other icons for choosing targeting criteria may be displayed including but not limited to the geographic region of the customer or the call type of the audio file. Each icon corresponds to an interface that uses the icon name as its primary targeting criteria (e.g. if the agent icon 413 were selected the resulting interface would first target interaction files based on the agent responsible for the interaction). Any type of metadata associated with an interaction file can be used as a targeting criteria. Thus, with more detailed client provided metadata for interaction files more icons may be displayed in the interface illustrated by FIG. 4B. In some embodiments, multiple icons may be selected simultaneously to allow for further narrowing of the interaction files.

When the interaction management system receives an input at the arrival patterns icon 406 the system responds by using arrival patterns of an interaction as a targeting criteria. Arrival patterns may be the time (time of day, day of week, time or year, etc.) an interaction is received, the call density at that time or any other pattern observable upon receipt of a call. Thus, the interaction management system may allow the user to filter interaction files based on their time of arrival or the call density upon at the arrival time of the interaction.

The call queue icon 408 corresponds to using a targeting criteria that filters the interaction files by the virtual queue in which they were categorized by the client. Call queue metadata may be provided in the client provided metadata.

The handle time icon 410 corresponds to using handling time of the interaction as a targeting criteria. In some embodiments, handling time may be the length of a call or other audio interaction. The start and end time used to calculate handling may vary depending on the embodiment.

The location icon 412 corresponds to using the location of the client that received the interaction, for example, the call center that a call was received. If a particular client has call centers in Omaha, Nebr. and Kansas City, Mo. the interaction management system would provide an option to target interactions based on the location at which each interaction was received. In some embodiments, location metadata is provided in the client provided metadata.

The agent icon 413 corresponds to using the agent that handled the interaction as a targeting criteria. The agent responsible for each interaction is typically identified in the client provided metadata and may be stored in the interaction file as an agent ID or the agent's name.

The transcript key phrase icon 414 allows a user of the interaction management system to target interactions based on a specified key phrase. The key phrase may be specified by the user or suggested by the interaction management system. Once a key phrase has been specified or selected the interaction management system may target only interactions that contain that phrase in the transcript of the interaction file.

The agent words-per-minute icon 415 corresponds to using the words-per-minute spoken by the agent in an interaction as a targeting criteria. Word-per-minute metadata may be calculated based from time-stamped transcripts in the interaction file.

The transcript sentiment icon 416 corresponds to using detected or recorded sentiment of a call as a targeting criteria. Thus, all interactions with a negative customer sentiment may be targeted for further analysis by the interaction management system.

The geographic region of an interaction may be used as a targeting criteria. In this case, the client provided metadata would indicate the region of a customer in an interaction based on client records or other information.

The call type of an interaction may be used as a targeting criteria as well. The call type may be designated in client provided metadata or may be assigned by the interaction management system.

In some embodiments, the interaction management system may provide drop down menus or other means to select targeting criteria. Instead of using a separate user interface, the options for targeting criteria may be included in the targeting interface so that the user may choose any targeting criteria and, in response the interaction management system will display the corresponding targeting interface while still displaying the targeting criteria options.

FIG. 4C illustrates an example targeting interface resulting from the selection of the handle time icon 408 in accordance with some embodiments. The selection of the handle time icon 408 indicates that the observer would first like to target interactions based on interaction duration or handling time. On the left side of the targeting interface, user interface elements for the selection of general targeting criteria are displayed. The general targeting criteria may be made available to the observer in the targeting interface independent of the observer's selection in the interface of FIG. 4B. General targeting elements may include but are not limited to a campaign targeting element 418, an observed interaction targeting element 420, a date range targeting element 422, and an interaction duration targeting element 424. In addition to the general targeting criteria elements, the targeting interface of FIG. 4C contains various graphics to aid in targeting interactions based on the selection from the targeting interface of FIG. 4B including but not limited to a primary targeting plot 426, a secondary targeting plot 428, interaction type plot 430, and an interactions-by-agent plot 432. Those of skill in the art recognize that there are a large number of possible data representations that could be used instead of any of the plot visualizations illustrated in FIG. 4B and that many of these graphs or plots could be useful in relation to interpreting interaction metadata. The targeting interface also includes a “load to analytic campaign” icon 434 that allows the observer to load the current selection of interactions to an analytic campaign at any time in the targeting process.

The campaign targeting element 418 is an element that may allow the observer to narrow the interaction files based on each interaction file's previous inclusion in an analytic campaign. For example, if a first analytic campaign determined that the root cause of the first campaign was the ineffective use of an internal tool, a second campaign might investigate whether the tool was effective for particular call center locations. Thus, the observer might want to first narrow the interaction data to those interactions that were involved in the first campaign before further narrowing to investigate each call center location of interest.

The observed interaction targeting element 420 is a user interface element that may allow the observer to narrow the interaction files based on whether they are observed or unobserved. The date range targeting element 422 is a user interface element that allows the observer to narrow the date range of the interactions. The interaction duration targeting element 424 is an element that allows the observer to narrow interactions based on their duration.

The primary targeting plot 426 is a plot that is determined based on icon selection for the interface of FIG. 4B. In this example, because the handle time icon 410 was selected in the previous interface, a plot of handle time versus interaction date is displayed in the primary targeting plot position. The primary targeting plot is not limited to being a scatter plot nor is it limited to have the date of the interaction be the second variable. In some embodiments, the primary targeting plot is configured to receive selections for targeted interactions directly on the plot.

The secondary targeting plot 428 allows for additional narrowing of the targeting criteria and may be configured based on a selection of a second icon from the initial targeting interface of FIG. 4B or it can be configured by a pull down menu or another suitable user interface element that allows selection from multiple options as illustrated in FIG. 4C. The secondary targeting plot may also be configured to receive selection from the observer to further narrow the targeting criteria.

The interaction type plot 430 serves to provide additional information about the types of interactions represented in the current selection of interactions for a potential analytic campaign. In other embodiments, the interaction type plot 430 may be replaced with any suitable plot that provides enriching information. Additionally, the region occupied by the interaction type plot 430 may be configured to display another plot chosen by the observer.

The interactions-by-agent plot 432 is also a plot meant to provide enriching data about the current selection of interactions. The interactions-by-agent plot 432 is similar to the interaction type plot 430 in that both may be configurable by the observer or replaced with different plots. Additionally, the plot displayed in the location of the interactions-by-agent plot 432 can be determined by the interaction management system based on the chosen primary targeting plot 426 and secondary targeting plot 428.

FIG. 4D illustrates a process of an observer selecting a set of interactions using the primary targeting plot in accordance with some embodiments. In some embodiments, an observer may select interactions directly from the primary targeting plot using a clicking and dragging motion to select all points within the selection area 436. In this example, the observer chooses to select all interactions with a duration longer than about 8 minutes.

FIG. 4E illustrates the result of selection 436 along with further narrowing steps taken by the observer using the targeting interface in accordance with some embodiments. The highlighted interactions 438 in primary targeting plot 426 indicate the current selection of interactions. The observer also takes further narrowing action 440 by selecting the billing column of the secondary targeting plot 428. Action 440 narrows the selection to include only interactions in the billing interaction queue. Additionally, a list of the currently selected interactions 442 may be generated in response to a selection of interactions from the observer.

FIG. 4F illustrates an observer selection of additional interactions by changing the secondary targeting plot 428 to show interaction transcript text in accordance with some embodiments. In order to make another narrowing selection the observer uses the pull down menu 443 to select “Transcript Text.” This action changes the secondary targeting plot 428 to a bar graph displaying common phrases from the transcripts of all of the currently selected interactions. The observer selects 444 the “Credit” column thereby narrowing the selected interactions to only interactions that have the word “credit” in the transcript, are from the billing interaction queue, and have a duration greater than about 8 minutes. Additionally, the list of currently selected interactions 442 is updated to reflect the narrowing of the selection. FIG. 4G illustrates the interface result of an observer selection of the load to analytic campaign icon 434 in accordance with some embodiments. Upon selection of the load to analytic campaign icon 434 the targeting interface displays the list of interaction files 442 that are to be added to the analytic campaign. The targeting interface also displays a confidence level calculation element 446 that calculates the number of interaction observations that need to be made in order to properly identify a root cause. The confidence level calculation may be completed based of a selection by the observer of a required confidence level, which may be accomplished through any suitable means. The observer may end the targeting process and add the selected files to an analytic campaign by selecting the add interaction data to campaign icon 448.

### Presenting Interactions in a Workflow Interface

Once the observer uses the targeting interface of the interaction management system to target unobserved interactions as part of an analytic campaign the interaction management system may provide a workflow interface. A workflow interface may present interactions that require observation for an active analytics campaign. An active campaign is a campaign that has not yet reached the campaign goal for number of observations.

Unobserved interactions may be presented to the user as part of a list of interactions to observe or simply display in succession upon the completed metadata capture of a previous interaction. In some embodiments, the workflow interface may utilize campaign priority to determine the highest priority interactions requiring metadata capture by an observer participating in the capturing interaction metadata process 115.

In addition to presenting interactions for observation, the workflow interface may display information on the status of various campaigns created by an observer or administrator or other information pertaining to the operation of the interaction management system.

### Capturing Interaction Metadata

FIG. 2A is an illustration of the capture interface before metadata associated with a targeted interaction has been captured in accordance with some embodiments. The capture interface may be used during a playback of a prerecorded unobserved interaction received by the interaction management system or, alternatively, during a live interaction between an agent and a customer. The interface is comprised of a number of different interface elements each having functions contributing to allowing an observer to capture enhanced metadata including a timeline region 200, a comment input box 201, an interaction recording region 202, an interaction state selection region 204, a sentiment selection region 206, and a timeline event selection region 208.

Interaction metadata, as described can be separated in to multiple categories including interaction transcript data, timeline entries, and an active campaign. The capture interface allows the user to assign timeline entries to an interaction based on perceived events in the audio recording of the interaction. The capture interface provides a variety of timeline entry types to apply to the interaction that fall under categories including but not limited to interaction states, customer sentiment, and timeline events.

Interaction states represent the typical actions that should be performed by an agent for every interaction. The interaction states available to an observer in the capture interface may be a predefined list corresponding to the type of interaction being received or may be selected by an administrator. When an interaction state is selected by an observer the timeline entry lasts until the next state is selected. Thus, a metadata entry for an interaction state has a start and end timestamps corresponding to timestamps of the interaction audio file.

Interaction states function to organize the call into sections that are more easily presentable to personnel in a customer relations environment. For this reason, call states are generally selected to be representative of the typical states of all interactions in a campaign and are only meant to be selected once per interaction. In some embodiments, a separate interaction state may exist for a customer being placed on hold by the agent, which can be selected multiple times by an observer.

Customer sentiments are similar to interaction states as they are associated with a time period (having a starting an ending timestamp as opposed to a single timestamp). The observer is generally given at least three options to represent a customer's sentiment at any time during an interaction. In embodiments where there are three sentiment icons the sentiments may be happy, neutral, and unhappy or any equivalent emotion variants. The sentiment of the customer at a point in the interaction in relation to other timeline events provides rich and useful customer service data that may be used, in conjunction with other timeline entries, to identify a problem or determine a root cause. When an observer applies a customer sentiment the customer is presumed to display that sentiment until the observer interacts with another sentiment icon thereby created a sentiment period. Important metrics such as the frequency of each sentiment, or the ending sentiment of a call can be generated from customer sentiment metadata.

In addition to being an observer selectable state, in some embodiments, the sentiment of a customer is determined automatically by the interaction management system by analyzing the interaction transcript for negative words or phrases while analyzing the audio file for changes in tone.

Timeline events are metadata tags for events that may occur during interactions with a customer. Event types may be selected in advance of the interaction to be displayed in the timeline event selection region 208 or may be selected automatically based on the type of business of the observer or the type of interaction being received (billing inquiry, as opposed to IT inquiry etc.). Timeline events may be grouped by event type. In varying embodiments, event types include but are not limited to comments, tools, treatments, keywords, knowledge, agent behaviors, problems, resolutions, and sale. In some embodiments, particular event types may have binary fields that indicate whether the event was successful or unsuccessful in resolving a customer's problem.

Comments are observer customizable timeline events that can be written as the interaction is being played back during the metadata capture process. Comments may be used by an observer to describe events that are not covered by another type of timeline event. Comments like this one are included in the text data for an interaction file and can be included in search results for words or phrases in an analytic campaign.

The problem timeline event is a timeline event that permits the observer to write a description of the problem the customer is experiencing (aka the reason for the interaction). Additionally, the problem timeline event has a field that indicates whether the problem was resolved during the interaction with the agent or if the problem remained unresolved.

The resolution timeline event is the corresponding timeline event to the problem timeline event. When an observer selects a resolution timeline event the resolution timeline event may be automatically associated with the immediately preceding problem timeline event. The resolution timeline event allows the observer to input a description of the attempted resolution. Additionally, the resolution timeline even may have a binary field that indicates whether the attempted resolution was successful. This field may be linked to the resolved/unresolved field of the problem timeline event such that if the resolution is marked as successful the problem event is automatically switched to a resolved status.

The tool timeline event may allow for the evaluation of tools commonly used in call centers. Tool usage data may be combined with other metadata associated with the interaction to determine the root causes of dissatisfaction with call centers. A tool timeline entry may additionally provide information about how the tool was used allowing for more detailed data. for example, if a network coverage tool was used to diagnose a poor network signal reason for call, the inputs to the network coverage tool might be included in the tool timeline entry. If the agent instead used a searching tool the input query might be automatically included in the timeline entry. Consequently, metadata associated with the tool timeline entry can be explicitly generated by the observer or automatically generated and included in the interaction file based on actions taken by the agent.

Agent behavior timeline events indicate particular standard actions for agents during an interaction. Further analysis of agent behavior metadata may be used to evaluate individual agents or training procedures to determine agent effectiveness. User sentiment and other interaction context in the timeline may be associated with the agent behavior in the interaction file. For example, if a change to an unhappy sentiment is frequently captured subsequent to a particular agent behavior of a particular agent, feedback could be given to provide more training to the agent on how to properly perform the identified behavior.

A treatments timeline event is similar to an agent behavior event except that it may be associated with particular problem captured by the observer in the interaction allowing more detailed evaluations regarding which treatments are successful at resolving particular types of problems.

A knowledge timeline event is a timeline event indicating an agent providing knowledge to the customer during an interaction. A knowledge timeline event has as field for a comment about the knowledge provided by the agent. In some embodiments, a knowledge timeline event may have an additional field for link to a source of the provided knowledge.

A keyword timeline event is a timeline event that indicates the usage of a keyword by the agent or the customer during an interaction. If the capture interface is configured with appropriate keywords the usage of keyword timeline events help to categorize the interaction and locate important sections of the call. Keyword timeline events may also be generated using the transcript of the interaction. In this case, the keyword event icon corresponding to the keyword timeline event provides a noticeable visual indication of the usage of a keyword.

A sale timeline event indicates the point that a sales pitch is made in an interaction with a potential customer. The sale timeline event may have a field for the observer to provide a description of the sale event, a field indicating the item or service being sold, and a field indicating if the sale was successful.

Other standard event types are possible and the interaction management system is designed to be customized by an administrator. In some embodiments, an administrator is enabled to customize event types available to observers of a campaign as well as the individual timeline events within each event type. In some embodiments, the review interface may allow the option to change one timeline event to a different timeline event, while maintain the timestamp or content metadata associated with the previous event.

Once again referring to FIG. 2A, the timeline region 200 is a region where a timeline indicating a variety of possible timeline entries is displayed to aid the observer in capturing appropriate interaction metadata. A timeline may be displayed in a vertically descending or ascending manner or a horizontally extending manner. When a timeline entry is selected by an observer, a visual representation of the entry termed a “timeline icon” corresponding to the metadata of the timeline entry is displayed within the timeline region 200.

The comment input box 201 is a text entry field that allows comments to be entered directly into the timeline and given a timestamp corresponding to the current time of the recording. Any text submitted via the comment input box 201 is saved as a timeline entry in the interaction file and displayed in the timeline region 200 as a timeline icon.

The playback region 202 may include icons representing the current playback time of the interaction audio file, whether the interaction has already been recorded or the interaction metadata are being captured while the interaction is live. Playback region 202 also provides a region for interacting with the audio file of the interaction including standard rewind, fast-forward, and play/pause icons configured to navigate the audio file. In addition to these standard functions, the playback region may be configured to display a waveform indicating the volume/intensity of the interaction. The waveform may be additionally configured to be color coded to the customer sentiment of the interaction at any given moment during the interaction file to provide further detail. The waveform may be additionally labeled with events from the timeline 200 as event labels. In some embodiments, the precise timestamp of a timeline entry or event may be modified based on audio analysis of the audio file associated with the interaction. For example, a timeline event may be captured by an observer but only when a break in the conversation has occurred. Therefore, when an observer goes back to the timestamp for the event the event may have already occurred in the audio file. By analyzing the audio file for periods of active conversation and comparing that with a timestamped transcript of the conversation the actual time of the timeline event can be determined.

The interaction state selection region 204 allows the observer to select the state of the interaction based on the context of the conversation between the customer and the agent. When an interaction state is selected the interaction state by the observer the corresponding icon in the interaction state selection region is highlighted to indicated the current state of the call.

The sentiment selection region 206 is comprised of at least three icons indicating the sentiment of the customer. For the duration of the sentiment period the sentiment of the customer is indicated in the timeline displayed in the timeline region 200.

The timeline event selection region 208 provides an interface for the observer to select an event type icon to bring up an event palette, which displays a plurality of icons representing timeline events of the selected event type that may be chosen. When an entry is chosen, the entry receives a timestamp corresponding the current time of the recording as displayed in the interaction recording region 202, added to the interaction metadata, and an associated event icon is displayed in the timeline region 200. The timeline event selection region 208 may also be configured to display individual timeline entries for selection for inclusion in the timeline instead of grouping the events by event type.

FIGS. 2B through 2H illustrate an example process of an observer capturing interaction metadata while recording an interaction in accordance with some embodiments. This example capturing process is just one example of capturing interaction metadata and the particular events shown are not intended to be limiting. FIG. 2A illustrates the capture interface before the interaction has started recording. FIG. 2B illustrates the beginning of the timeline and the changes in the user interface elements in accordance with some embodiments.

In FIG. 2B the first event in the timeline 210 is indicated by a “Call Start” icon located within the timeline region 200 indicating that a. Additionally, the recording icon in the interaction recording region 202 may also be modified in order to indicate that the interaction has begun. The interaction time is also indicated in the interaction playback region and in FIG. 2B it indicates that the audio playback has been playing for the last 2 seconds. Additionally, “Call End” icon 211 is displayed at the bottom of the timeline because the current interaction is prerecorded and so the client provided metadata already indicates the duration of the audio file, in this case, 5:21.

FIG. 2C illustrates the next state of the example interaction in accordance with some embodiments. In FIG. 2C the observer has selected the “Opening Preamble” interaction state icon from the interaction state selection region 204 to indicate that the agent has recited an opening preamble in answering the interaction. The second event in the timeline 212 is added to the timeline region 200 adjacent to and below the “Begin” icon 210 indicating that the two events are consecutive and that the first event 210 precedes the second 212. A waveform version of the timeline icon is also placed in a location corresponding to the timestamp of the event. The waveform icon may display text relating to the icon when an observer moves the mouse to hover over the icon. Additionally, the “Opening Preamble” icon may be highlighted in the interaction state selection region 204 to indicate that the “Opening Preamble” state has already begun. The timeline event 212 also includes a timestamp of “00:00:04” to indicate that the opening preamble state began at 4 seconds into the interaction.

FIG. 2D illustrates a selection of a sentiment icon in the sentiment selection region 206 in accordance with some embodiments. The selection of the neutral sentiment from the sentiment selection region 206 results in the display of a third icon 214 within the timeline region 200 just below timeline icon 212 indicating that the customer is displaying neutral sentiment in response to the opening preamble event 212. The sentiment selection region 206 may display the currently active sentiment of the customer. Additionally the waveform of the playback region 202 changes indefinitely to a color (usually yellow) corresponding to the neutral sentiment.

FIG. 2E illustrates a selection of a “Call reason” timeline entry from the timeline event selection region 208 after a selection to begin the second state of the interaction, “Verification,” in accordance with some embodiments. Upon selection to indicate the second state of the interaction, “Verification,” the verification icon is highlighted within the interaction state selection region 204 and an icon 216 is added to the timeline region 200 (and the waveform is correspondingly updated as well). The pin validation icon 217 is also applied to indicate the form of verification. The observer then selects the call reason timeline entry and a call reason icon 218 is displayed in the timeline region 200. The event displays additional text description added by the observer about the reason for the call along with a tag indicating that the issue is currently unresolved. The indication of the customer's sentiment has not changed and so a new sentiment icon has not been selected from the sentiment selection region.

FIG. 2F illustrates a submission of a comment by the observer describing an event in accordance with some embodiments. Between the time of FIG. 2E and the time displayed in FIG. 2F the observer chose to enter text into the comment input box 201 to describe the action of the agent in the interaction (in this case the observer is the person reviewing the interaction, rather than the agent that originally responded to the interaction). The comment may be displayed in full 220 in the timeline region 200 in the order of the timeline. Possibly as a result of the agent action described by the comment the customer begins to display a negative sentiment and the observer chooses to select the unhappy sentiment from the sentiment selection region 206, which is then displayed 222 in the timeline region 200 indicating the change of user sentiment. The waveform also reflects by changing the remainder of the recording a red color (not visible in black and white figures).

FIG. 2G illustrates a series of events entered by the observer that result in a resolution to the problem represented in the timeline by event 218 in accordance with some embodiments. The observer has entered events 223, 224, 226, and 228 describing the agents attempt to make resolve the billing issue. For icon 223 the observer notes that the agent put the customer on hold (also indicated by the flat waveform) and so changes the state of the call to a hold state and adds a comment discussion the reason for the hold state. The timeline event 224 represents the agent attempting to gain knowledge of why the problem occurred and so a “client knowledgebase” event type symbol is displayed in the timeline next to the event 224 details. Upon the agent receiving knowledge of the problem the observer indicates that the agent resumes the call and so indicates on the timeline the hold state started in 223 is no longer in affect 226. The observer then uses a treatment timeline event to indicate the delivery of the knowledge from the agent to the customer 228 which constitutes a resolution to the reason for the call. Note that the “unresolved” icon inside event 218 is replaced with a “resolved” icon.

FIG. 2H illustrates the final states of the example interaction in accordance with some embodiments. The observer indicates that the interaction is in the “Call Closing” state and the corresponding event 234 is displayed.

FIG. 2I illustrates an interface for choosing interactions in a campaign to be assigned enhanced metadata. The interface displays a spreadsheet indicating interactions included a campaign that may be observed by a user of the interaction management system.

### Displaying Interaction Metadata

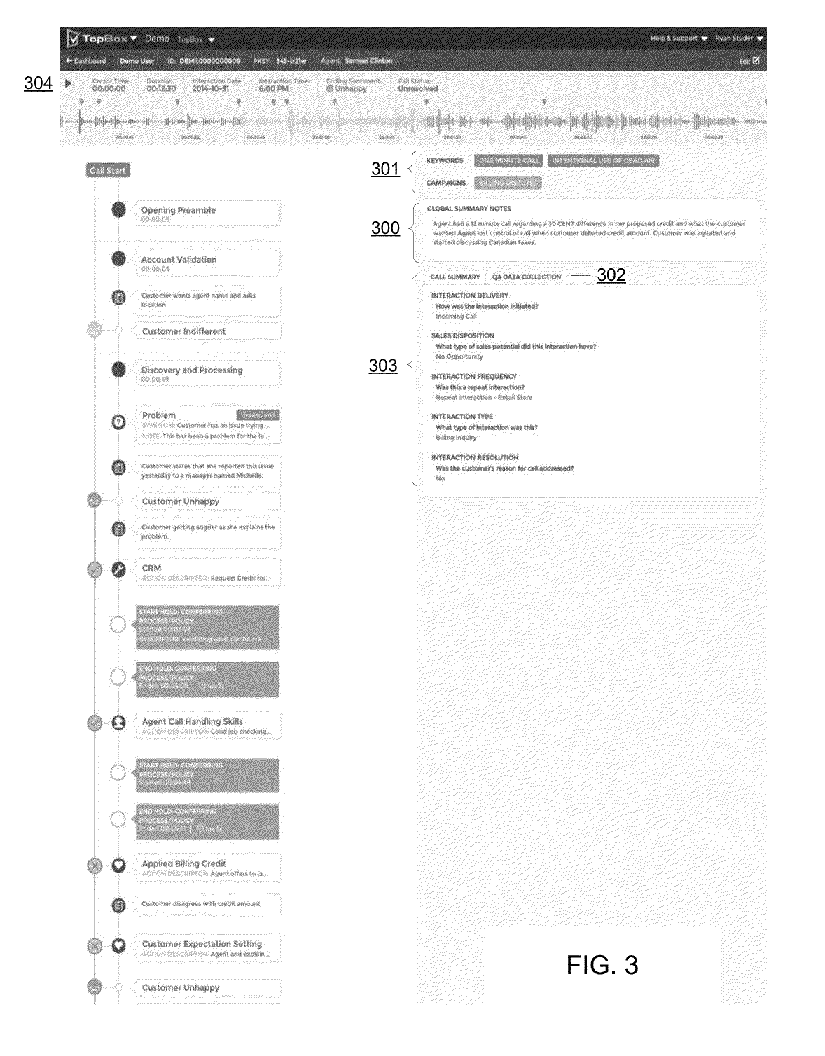

In addition to being able to view the timeline of an interaction as it is being recorded, the interaction management system can present an observed interaction timeline for viewing by the observer as indicated in step 110. FIG. 3 illustrates the review interface of the interaction management system displaying an example interaction in accordance with some embodiments.

The timeline of the review interface is similar to that of the capture interface, however, the regions that allow for metadata to be applied to the interaction file may be replaced with regions that facilitate a potential review process. In accordance with some embodiments, the review interface has a global summary region 300, a metadata tag region 301, a quality assurance region 302, a call summary region 303, and an informational region 304 in addition to the same timeline interface.

The global summary region 300 may include a summary written by the observer or automatically generated based on the events previously recorded in the timeline of the interaction.

The metadata tag region 301 may display icons representing actionable metadata labels, active and inactive campaigns, keyword tags, or any other tags that have been applied as post-observational metadata.

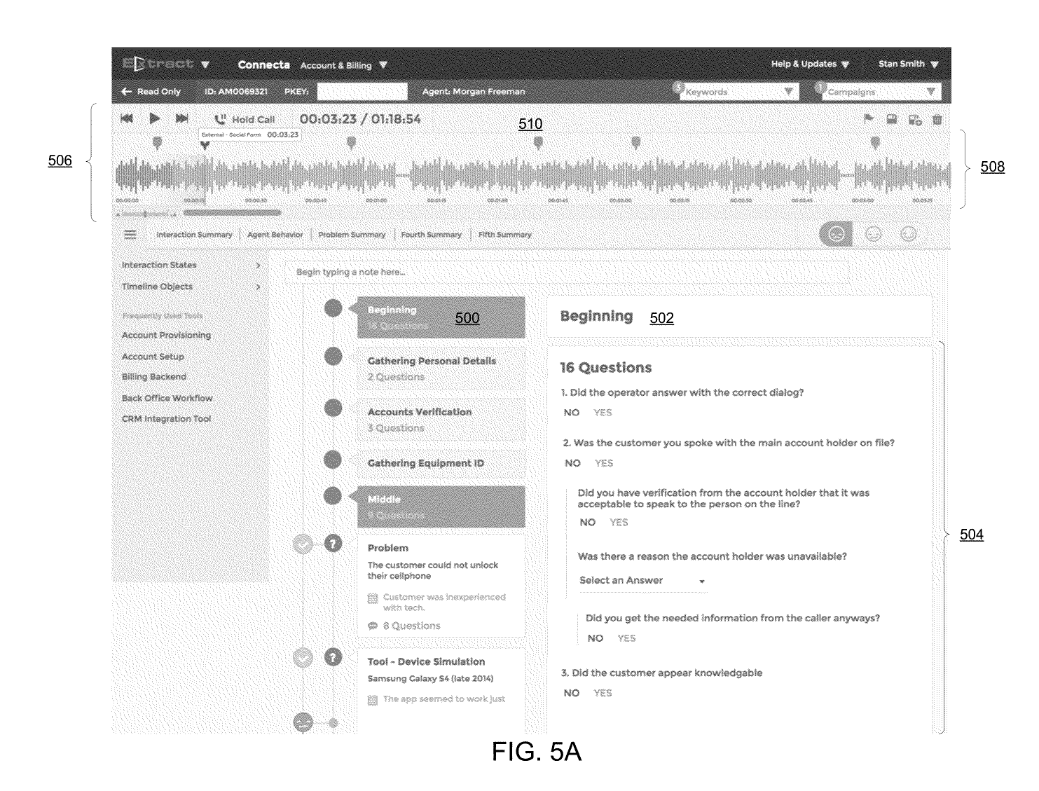

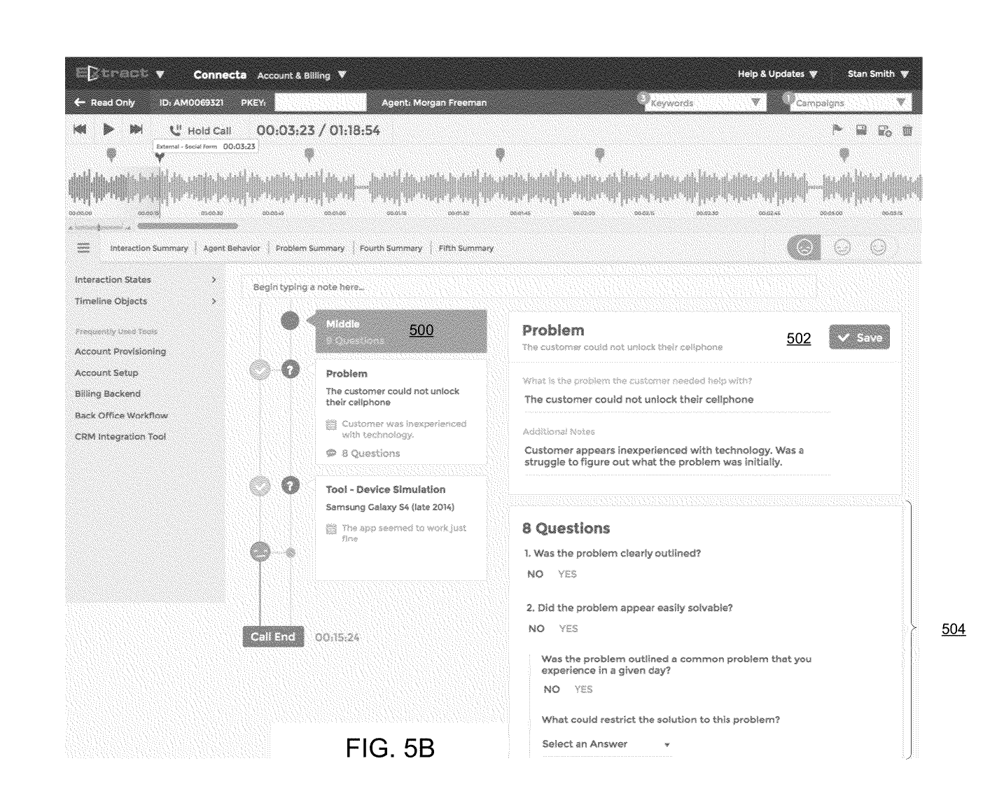

The quality assurance region 302 may include predetermined questions, questions generated based on the type of interaction (e. g. if the interaction is an IT then default IT survey questions are used), or questions generated based on timeline entries of the interaction. The answer to the questions in the quality assurance region may be recorded by the observer or generated based on the recorded events in the timeline of the interaction. The process of generating quality assurance forms is further discussed with reference to FIGS. 5A-5B.

The call summary region 303 is a form that may be automatically filled by the interaction management system or filled out manually by an observer or a combination of both. The questions may be automatically generated by the metadata from the call or configured by an administrator. The call summary form may display a more in depth summary of the call than the global summary.

The informational region 304 displays client provided metadata and other available statistics associated with the interaction including but not limited to an interaction date and time, an interaction duration, an ending sentiment, an interaction status, and an agent name or ID corresponding to the agent responsible for the interaction.

While using the review interface, the timeline 200 may be configured to scroll such that it is synchronized with the playback of the audio file. When the timestamp of an event is reached the review interface may be configured to highlight the event and scroll down the timeline bringing the highlighted event to the top. In other embodiments, the waveform may be configured to skip to the location of a timeline event upon the review interface receiving a selection of an event icon in the timeline 200. These functions allow an observer to follow along on the timeline while the audio file of the interaction is synchronized with the part of the timeline currently of interest to the observer.

Through a quick inspection of this example interaction timeline, important factors about the interaction can be determined by the observer that would otherwise only become apparent after reading through a transcript of the interaction or listening to the entire interaction.

### Generating Quality Assurance Forms Based on Interaction Metadata

After an interaction has been observed and metadata has been captured, the interaction management system may provide additional opportunities to associate more descriptive data about the interaction with the interaction file using generated quality assurance forms. The process of generating quality assurance forms based on interaction metadata 130 is explained with reference to FIGS. 5A and 5B below.

In some embodiments, the interaction management system may provide a separate interface for the creation of observation forms. The administrator may design forms for completion after metadata capture is complete. In addition to providing the ability to write the questions an administrative form interface may include options to select the question type, select global questions that pertain to the entire interaction or static questions that may be answered multiple times during an interaction, create a scoring scheme for the questions, associate triggering events with particular answers to particular questions, and create question hierarchies wherein the answer to one question generates more sub-questions.

In addition to observer created forms, in some embodiments, the interaction management system may generate survey questions automatically based on standard industry templates. For example, if an observer runs an IT business the interaction management system may provide questions directed toward whether the technical problem was resolved etc.

In addition to providing a means to generate survey forms, the interaction management system also provides an interface with which to answer the generated survey questions while viewing the interaction, and optionally listening to the audio file associated with the interaction. In some embodiments this quality assurance interface may be integrated with the review interface discussed with reference to FIG. 3 above.

The subject event 500 is the event in the timeline of the interaction file that is currently selected for review or editing. In the case of FIG. 5A the subject event is the beginning interaction event. The review interface may also optionally display the number of questions associated with each even on the timeline. This may be a consistent feature of the review interface or it may only be used while the observer is completing quality assurance forms.

The subject event region 502 is a region of the review interface that may be dedicated to displaying additional details about the subject event 500. In addition to displaying details about the subject event 500 the subject event region 502 may provide an interface for an observer to make edits to the subject event. In the example illustrated in FIG. 5A there are no details pertaining the “beginning” even so the subject event region remains empty.

The quality assurance region 504 of the review interface provides an interface for an observer to view and edit the answers to generated (either by the system or by the observer) quality assurance forms directed to the subject timeline event 500. In some embodiments the answer to a question may be associated with a current timestamp or time period if an observer answers the question while playing the audio file of the interaction. FIG. 5A displays the first 3 of 16 questions relating the subject timeline event 500 within the quality assurance region 504.

FIG. 5B illustrates an example of the review interface of FIG. 5A with a different subject timeline event 500 in accordance with some embodiments. In this case, the subject event region 502 contains additional details describing the problem event that may be edited by an observer. Additionally, the questions located in the quality assurance region have changed and are now directed to the new subject timeline event 500.

### Providing Campaign Analysis Tools and Updating Interaction Metadata Based on Campaign Analysis

The steps of providing campaign analysis tools 135 and updating interaction metadata based on campaign analysis 140 may be accomplished by an analysis interface provided by the interaction management system. Upon the creation of an analytic campaign an observer may access the analysis interface using an interface like the interface illustrated in FIG. 4B.

The analysis interface is configured to provide user interface elements that apply statistical methods to the data in the analytic campaign by comparing timeline entries across all interactions in the analytic campaign. Upon completion of a statistical analysis an observer may identify a root cause.

For example, an observer may create an analytic campaign of interactions that have been identified as fraudulent attempts to access customers' accounts. Using the statistical analysis methods provided by the analysis interface the observer may discover a pattern of customer behavior that is indicative of fraudulent behavior at a statistically significant level.

In addition to identifying a root cause, the analysis interface may also be configured to allow an observer to take action on the identified root cause by updating metadata associated with all interactions that have traits identified to be associated with a root cause. An observer may choose to label all interactions that have a pattern identified in the analytic campaign with an actionable metadata label. The metadata update extends to interactions outside of the original campaign and may be continually applied automatically even as new interactions are observed.

The metadata labels applied to interaction files may also be configured to trigger a system action such as an alert. For example, in the fraudulent interactions example the observer may wish to update all interactions that exhibit the same patterns of interactions found to be fraudulent to be marked as potentially fraudulent. The interaction management system then updates all interactions related to the observer that display the pattern of a fraudulent interaction with a “potentially fraudulent” label. The observer may then want to further configure the label to trigger the observer's internal system to notify the fraud detection department of a potential fraud associated with a particular interaction.

### Administration Console

The functionality described above may be further customized using the administration console. The administration console allows for the customization and configuration of many of the features of the interaction management system including configuring campaigns, configuring event types, hold events, keywords, interaction states, and forms.

The administration console provides a user interface allowing an administrator of the interaction management system to configure the interaction management system according to the specific needs of a client of the interaction management system. The administration console may allow for separate configuration for each client being served by the interaction management system.

An administrator using the administration console may create new campaigns, manage the status of existing campaigns, or modify criteria for automatically generated campaigns. To create a new campaign, an administrator may initiate the interaction targeting workflow described with regard to FIG. 4A-4G. The administration console displays a list of the current campaigns in the interaction management system. Upon selection of any of the listed campaigns an administrator may close the campaign or make it active again depending on its current status.

The administration console may also provide a user interface (e.g. similar to the targeting interface) to select criteria for automated campaign generation. Existing automated campaigns can be edited to retroactively change the campaign criteria, thereby altering the interactions included in the campaign. Additionally the administration console may allow an administrator to apply the criteria used for a manually created campaign to a new automated campaign.

In addition to managing campaigns, the administration console provides a user interface for customizing event types, hold events, keywords, interaction states, and forms. In each case, the administration console displays a list of all of the timeline events that are available during enhanced metadata capture. The list may be divided into separate tabs based on the type of time event for better organization.

An administrator may navigate through the list of timeline events and may create a new event or edit existing events to fit the needs of any client. Customization options include changing the name or associated icon of an event. In some embodiments, the administrator may also modify the event triggers associated with particular events.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter.

What is claimed is:

1. A method of labelling an audio file with observational metadata comprising:
receiving an audio file of an interaction between a customer and a customer service agent;
displaying, in a user interface a timeline region, an interaction playback region, a sentiment selection region, and a timeline event selection region;
receiving an input in the interaction playback region from an observer of the audio file to begin a playback of the audio file;
responsive to receiving the input beginning a playback of the audio file and displaying a timeline, in the timeline region, representing the interaction recorded in the audio file including at least an indication of a start time and an end time of the audio file;
at a first time during playback of the audio file, receiving a first selection of a sentiment from the observer in the sentiment selection region;
responsive to the first selection of the sentiment in the sentiment selection region:
displaying a sentiment icon corresponding to the selected sentiment in the timeline region labelled with the first time;
saving metadata to an interaction file, associated with the audio file, indicating the selected sentiment was expressed at the first time in the audio file;
at a second time during playback of the audio file, receiving a second selection of a timeline event from the timeline event selection region;
responsive to the second selection of the timeline event in the timeline event selection region;
displaying a timeline event icon corresponding to the selected timeline event labelled with the second time; and
saving metadata to the interaction file, associated with the audio file, indicating the selected timeline event occurred at the second time.

2. The method of claim 1, wherein the interaction playback region further comprises a waveform of the audio file, a pause/play button, and a hold call button.

3. The method of claim 2, wherein a color of the waveform of the audio file changes based on the selected sentiment.

4. The method of claim 2, further comprising, in response to the selection of the timeline event at the second time, displaying an indication of the timeline event on the waveform of the audio file at a location corresponding to the second time.

5. The method of claim 1, wherein the sentiment selection region of the user interface is comprised of three buttons representing happy, neutral, and unhappy sentiments.

6. The method of claim 1, wherein the timeline event selection region further comprises a list of event type group buttons, and further comprising, responsive to receiving a selection of one of the list of the event type group buttons, displaying a plurality of timeline event buttons corresponding to timeline events of the selected event type group.

7. The method of claim 1, wherein displaying, in a user interface, an interaction recording region, a sentiment selection region and a timeline event selection region further comprises displaying an interaction state selection region.

8. The method of claim 7, further comprising:
at a third time since beginning the playback of the audio file, receiving a third selection of a first interaction state from the observer in the interaction state selection region;
responsive to the third selection of the first interaction state in the interaction state selection region:
displaying a first interaction state icon corresponding to the first selected interaction in the timeline region labelled with the third time; and
saving metadata to the interaction file, associated with the audio file, indicating the interaction progressed to the first selected interaction state at the third time in the audio file.

9. The method of claim 8, further comprising:
at a fourth time after the third time since beginning the playback of the audio file, receiving a fourth selection of a second interaction state from the observer in the interaction state selection region;
responsive to the fourth selection of the second interaction state in the interaction state selection region:
displaying a second interaction state icon corresponding to the second selected interaction in the timeline region labelled with the fourth time;
saving metadata to the interaction file, associated with the audio file, indicating the interaction progressed to the selected interaction state at the third time in the audio file and that the duration of the first interaction state was the fourth time minus the third time.

10. The method of claim 1, wherein displaying, in a user interface, an interaction recording region, a sentiment selection region and a timeline event selection region further comprises displaying a comment input box.

11. The method of claim 10, further comprising:
receiving a text input in the comment input box at a fifth time since beginning the playback of the audio file;
responsive to receiving the text input:
displaying the text input in the timeline region labelled with the fifth time; and
saving the text input as metadata in the interaction file.

12. The method of claim 1, wherein receiving an audio file of an interaction between a customer and a customer service agent further comprises:
receiving transcription metadata, wherein transcription metadata is a transcription of the interaction between the customer and the customer service, having a plurality of words, each word having a timestamp indicating a time during the interaction at which the word was spoken.

13. The method of claim 12, further comprising;
automatically generating a timeline event based on the received transcription metadata and the audio file; and
displaying the automatically generated timeline event in the timeline region.

14. The method of claim 12, wherein responsive to the second selection of the timeline event in the timeline event selection region further comprises:
determining based on the received transcription metadata a time at which the selected timeline event occurred different from the second time;
displaying a timeline event icon corresponding to the selected timeline event labelled with the determined time; and
saving metadata to the interaction file, associated with the audio file, indicating the selected timeline event occurred at the determined time.

15. The method of claim 1, further comprising;
automatically detecting a change in customer sentiment based on the received transcription metadata and the audio file; and
displaying a sentiment icon based on the detected change in sentiment in the timeline region.
